(19) United States
(12) Patent Application Publication
(10) Pub. No.: US 2024/0149547 A1
(43) Pub. Date: May 9, 2024

(54) TABLETING DEVICE

(71) Applicant: GEA Process Engineering nv, Halle (BE)

(72) Inventors: Dirk Christiaens, Roosdaal (BE); Ivo Van den Mooter, Willebroek (BE); Koen Van De Voorde, Haaltert (BE)

(73) Assignee: GEA Process Engineering nv, Halle (BE)

(21) Appl. No.: 18/549,735

(22) PCT Filed: Mar. 10, 2021
(86) PCT No.: PCT/EP2021/056045

§ 371 Date: Sep. 8, 2023

(51) Int. Cl. B30B 11/08; B30B 15/02

(52) U.S. Cl. CPC B30B 11/08; B30B 15/022

(57) ABSTRACT

Tableting device including a rotary turret with a rotation axis including: an upper receptacle body (IO) provided with reciprocating upper punches, a lower receptacle body provided with reciprocating lower punches, a die table, die inserts; wherein the die table is provided with receiving recesses in which the die inserts are arranged; wherein the die inserts and the receiving recesses have a complementary form; wherein each die insert comprises at least one circular cylindrical outer surface with a die insert outer diameter (N), said surface acing an inner surface of the corresponding receiving recess, wherein each die insert includes a pair of working bores in which a pair of directly adjacent upper punches respectively reciprocate in use, and in which a corresponding pair of directly adjacent lower punches respectively reciprocate in use.

### TECHNICAL FIELD

The present invention relates to a tableting device comprising a rotary turret.

### BACKGROUND ART

The present invention relates to the increase of the production capacity of a tableting device, in particular a rotary tablet press. The production capacity depends on the attainable press speed and the number of punches that can be accommodated on the pitch circle.

Traditionally, it has been proposed to address the above mentioned problem by decreasing the tooling (e.g. punches) dimensions below the industry standards in order to accommodate more punches on the pitch circle, thereby increasing the production capacity (e.g. US 2009/0269433 A1). This tooling is also defined as non-standard tooling. The drawbacks associated with this approach are that the die insert becomes too small, leading to deformation and fixing difficulties.

To address these deformation/fixation issues, it has been proposed to introduce exchangeable die plates with die bores directly provided into the plate, thereby preventing the use of small exchangeable dies (e.g. WO2009/112886A). Nevertheless, this solution has drawbacks limiting the applicability to rotary tablet presses with small pitch circle diameter. Indeed, heavy tables cannot be easily handled. Alternatively, segmented exchangeable die plates were developed as disclosed in EP 1 316 411 B1. However, strict tolerances are required not only to ensure that the die bores match with the top and bottom punch tips but also to guarantee correct body diameter in order to increase the number of punches on a given pitch circle.

As an alternative to the increase in the output capacity of a rotary tablet press, tooling with multiple tips on the same punch has been proposed in GB191507881 disclosing the features of the preamble of claim 1. This old document (1915) shows that three tips are aligned with the three corresponding die bores arranged on a single exchangeable die insert. However, the impossibility to evaluate weight of individual tablets during compression process as well as an increased complexity may render this approach less interesting to increase in output capacity.

Similarly to GB191507881 (FIG. 2), US 2008/0145468 A1 proposes an exchangeable die insert with at least two or more bores arranged on a single die insert. The latter document differs from the former document not only in that it defines a specific shape for the die insert, namely a circular arc and/or a substantially kidney-shaped design die insert, instead of mandrel (i.e. circular shaped), but also in that the purposes of GB191507881 differs from those of US 2008/0145468 A1. Indeed, the rationale behind the circular arc shaped insert is to reduce fitting times, as well as to improve servicing and cleaning. US 2008/0145468 A1 therefore seeks to solve another problem. Furthermore, the solution outlined in US 2008/0145468 requires new die insert fixing solutions involving new development and reduction in economies of scales since they cannot be shared with those of standard die inserts.

### SUMMARY OF THE INVENTION

An object of the present invention is to address the above-mentioned drawbacks, in particular to obtain a high capacity and robust die table, preferably compatible with standard die insert fixing solutions.

In a first aspect of the invention, this and further objects are achieved by a tableting device comprising a rotary turret with a rotation axis including: an upper receptacle body provided with reciprocating upper punches, a lower receptacle body provided with reciprocating lower punches, a die table, die inserts; wherein the die table is provided with receiving recesses, in which the die inserts are arranged; wherein the die inserts and the receiving recesses have a complementary form; wherein each die insert comprises at least one circular cylindrical outer surface with a die insert outer diameter, said surface facing an inner surface of the corresponding receiving recess, wherein each die insert comprises a pair of working bores, in which a pair of directly adjacent upper punches respectively reciprocate in use, and in which a corresponding pair of directly adjacent lower punches respectively reciprocate in use.

By the provision of such a pair of working bores within each die insert, it has been made possible to increase the number of working bores while keeping the standard fixation traditionally used to fix the die inserts into the receiving die table. In this way, it is possible to directly benefit from the use of standard fixations. This is advantageous for a number of reasons, in particular as regards availability, costs, and mechanical stability.

It is noted that the term “a pair of working bores” is meant to encompass at least two working bores present in a single die insert; however, embodiments in which only two working bores are present in each die insert are preferred.

According to specific embodiments of the invention, the tableting device comprises one of more of the below technical features. It is noted that the features may be combined with each other in any manner:
wherein each upper or lower punch comprises a single tip adapted to reciprocate within the corresponding working bore;
wherein each upper or lower punch is a single piece;
wherein the pair of working bores is arranged circumferentially about the rotation axis;
wherein the pair of working bores is a pair of through bores opening on an upper and a lower face of the corresponding die insert;
wherein the die table comprises an upper and a lower face, wherein each die insert upper face is flush with the die table upper face;
wherein each die insert lower face is flush with the die table lower face;
wherein the at least one circular cylindrical outer surface comprises a first circular cylindrical outer surface and a second cylindrical outer surface positioned below said first surface, said first and second surfaces having the same outer diameter;
wherein each die insert comprises an annular outer groove positioned between the first and the second circular cylindrical outer surfaces;
wherein each die insert has an outer lateral surface, the dimensions of which meet the requirements of standard ISO 18084:2011(E);
wherein each die insert comprises only two working bores;
wherein the number of working bores is twice the number of die inserts;
wherein the number of upper punches is twice the number of die inserts;
wherein the number of lower punches is twice the number of die inserts;
wherein in each receiving recess, the inner surface is a first circular cylindrical inner surface positioned above a second circular cylindrical inner surface of said recess, said first and second surfaces having the same diameter;
wherein the diameter of the at least one outer surface is a value selected from 38.1, 30.16, 24 or 21 mm;
wherein each upper or lower punch comprises a barrel portion for guiding said punch in the respective upper or lower receptacle body, said barrel portion comprising a cylindrical outer surface with a barrel diameter, wherein the barrel diameter is lower than 45% of the die insert outer diameter;
wherein the barrel diameter is less than 14 mm, more preferably less than 12.5 mm;
wherein the diameter of the lower or upper punch tip is lower than or equal to the barrel diameter;
wherein each die insert is a single piece;
wherein each die insert is adapted to be inserted in a direction parallel to the rotation axis;
wherein the at least one circular cylindrical outer surface encircles the pair of working bores;
wherein the at least one circular cylindrical outer surface extends over an arc of at least 330°, preferably over 360°;
wherein the inner surface is a closed surface;
wherein each die insert comprises a further working bore, wherein the pair of working bores and said further bore are arranged on the same pitch circle;
wherein the number of lower punches is a positive integer multiple of the number of die inserts;
wherein the number of upper punches is a positive integer multiple of the number of die inserts;
wherein each upper or lower punch comprises two tips adapted to reciprocate within the corresponding working bores;
wherein the upper punch tips are arranged along two distinct pitch circles, and/or wherein the lower punch tips are arranged along the two distinct pitch circles;
wherein each die insert comprises a further pair of working bores, in which two tips belonging to a first and a second of the upper punches respectively reciprocate in use, wherein the two other tips belonging to the first and the second of the upper punches respectively reciprocate in use in the pair of the working bores belonging said die insert;
wherein each die insert comprises a further pair of working bores, in which two tips belonging to a first and a second of the lower punches respectively reciprocate in use, wherein the two other tips belonging to the first and the second of the lower punches respectively reciprocate in use in the pair of the working bores belonging said die insert.

### BRIEF DESCRIPTION OF DRAWINGS

In the following description embodiments of the invention will be described with reference to the drawings, in which

FIG. 1 discloses an example of a tableting device with a single tip punch according to the prior art;

FIG. 2 discloses an example of a tableting device with multiple tip punches according to the prior art;

FIG. 3 discloses a comparison between an embodiment of a tableting device according to the invention and an example of a tableting device according to the prior art;

FIG. 4 discloses an example of a lower punch according to the prior art (standard tooling);

FIGS. 5A and 5B disclose an example of a punch according to the prior art (non-standard tooling);

FIG. 6 discloses an example of a die insert according to the prior art (standard tooling);

FIGS. 7A, 7B and 7C disclose an embodiment of a die insert according to the invention;

FIG. 8A discloses an embodiment of a rotary turret without punches and die inserts according to the invention;

FIG. 8B discloses an embodiment of the rotary turret of FIG. 8A with die inserts;

FIG. 9A discloses a sectional view of a die table and punches according to the invention;

FIG. 9B discloses a side view of opposed punches according to the invention;

FIG. 10A shows a top view of an embodiment of the invention; and

FIGS. 10B and 10C are cross-sectional views along the line Y-Y of FIG. 10A, without and with, respectively, a die insert.

### DETAILED DESCRIPTION

The present invention will now be described in more detail hereinafter with reference to the accompanying drawings, in which embodiments of the invention are shown. This invention may, however, be embodied in many different forms and should not be construed as limited to the embodiments set forth herein; rather, these embodiments are provided for thoroughness and completeness.

In the below description, elements of the prior art having counterpart elements of corresponding function as in the subsequent embodiments of the invention are denoted by the same reference numerals preceded by a “P” for ease of understanding, but this is not to be construed that such elements do not differentiate from each other.

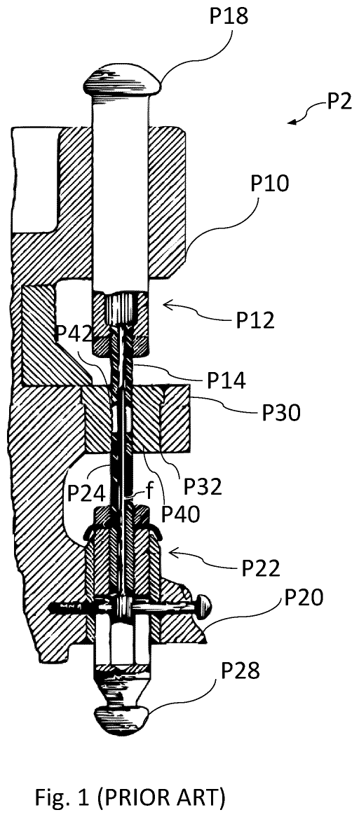

FIG. 1 discloses a transversal view of a tableting device P2 according to the state of the art. The device comprises an upper receptacle body P10 provided with reciprocating upper punches P12, a lower receptacle body P20 provided with reciprocating lower punches P22, a die table P30 provided with a plurality of exchangeable die inserts P40. The die insert P40 shown comprises a working bore P42. The die insert P40 is disposed in its receiving recess P32 in a form-fitting manner. In operation, the upper receptacle body P10, the lower receptacle body P20 and the die table P30 rotate synchronously about a rotation axis extending vertically. The upper receptacle body P10, the lower receptacle body P20 and the die table P30 form the rotary turret of the tableting device P2. A stator element of the tableting device is not shown in FIG. 1. Typically, the stator element comprises an upper and a lower cam profile guide or roller actuating respectively the upper P12 and lower P22 punches, when the punches P12, P22 rotate with their respective upper P10 and lower P20 receptacle body. The upper P12 and lower P22 punches can comprise an end surface P18, P28 that slides on a corresponding cam profile guide surface or rolls on a roller surface. The opposite end (tip) P14, P24 of the upper P12 or lower P22 punches can reciprocate in the corresponding working bore P42. In operation, a powder composition, for instance, is fed by a feeder assembly (not shown). The powder composition is then confined in a variable volume defined by the ends (tips) of the corresponding upper P12 and lower P22 punch, as well as the inner lateral surface of the corresponding working bore P42. During at least one rotation cycle, two opposed upper P12 and lower P22 punch ends (tips) get closer to each other and compress the powder composition so as to form a tablet, for example. The formed tablet is then ejected from the working bore. For instance, the corresponding upper punch tip end is extracted from its working bore, leaving a free opening, while the corresponding lower punch end moves upwards and preferably beyond the upper surface of the corresponding die so that the formed tablet is pushed out of the working bore P42. Then, the tablet can be transferred to another location, for instance an outlet. Once the working bore P42 is free, it can be filled again with a powder composition.

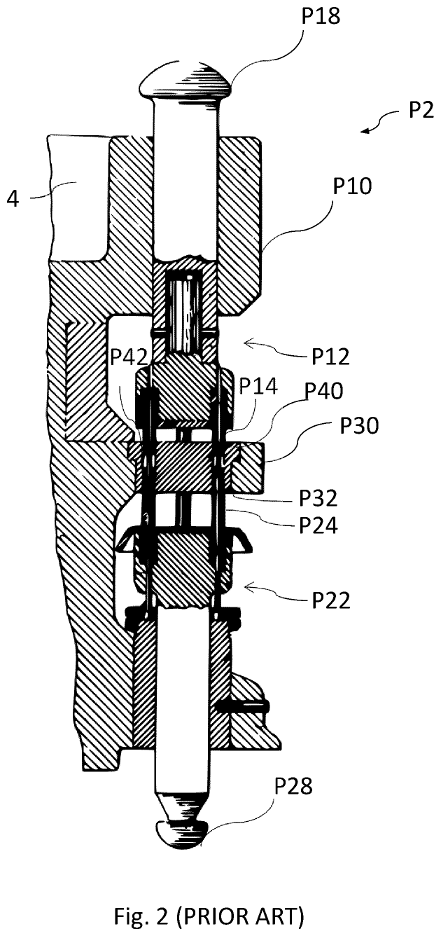

FIG. 2 discloses an alternative to the tableting device of FIG. 1. In the tableting device of FIG. 2, the upper P12 and lower P22 punches are adapted to receive three tips so as to increase the capacity. The free ends of the three tips can reciprocate in three corresponding working bores P42. This design does not allow the evaluation of the weight of individual tablets during the compression process well as increases complexity, thereby rendering this approach less interesting to increase in output capacity.

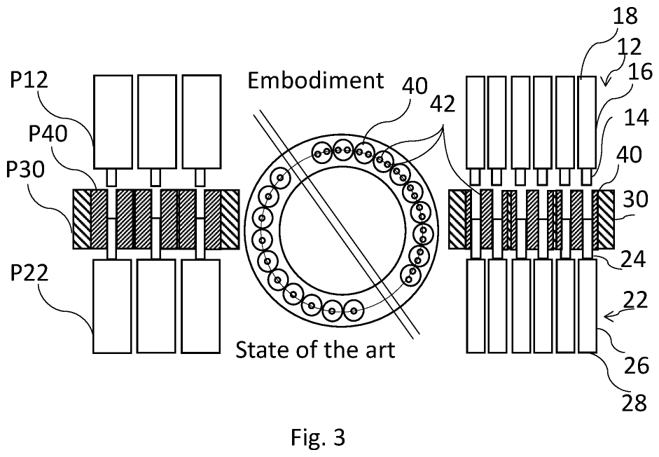

FIG. 3 discloses a schematic representation comparing a tableting device according to the another example of the state of the art (without stationary pin f as shown in FIG. 1) and that of the present invention. The prior art tableting device in FIG. 3 and the invention device have in common the outer lateral surface of the die insert. The invention differs from the state of the art in that it combines two upper/lower punches with one single tip 12, 22 aligned, respectively with two working bores 42 arranged in the same insert 40. The present invention makes it possible to increase the number of working bores 42 while keeping the standard fixation traditionally used to fix the die inserts 36 into the receiving die table 30. The solution of the invention can therefore directly benefit from the use of standard fixations, especially from their mechanical stability. In other words, no additional screw or assembly web are needed to fix the die insert as suggested in the prior art (e.g. US 2008/0145468).

FIG. 3 on the right hand side discloses a partial transversal view of the tableting device 2 according to the invention. The device 2 comprises an upper receptacle body 10 (not show) provided with reciprocating upper punches 12, a lower receptacle body 20 (not shown) provided with reciprocating lower punches 22, a die table 30 provided with a plurality of exchangeable die inserts 40. The die insert 40 shown comprises two working bores 42. The die insert 40 is disposed in its receiving recess 32 in a form-fitting manner. In operation, the upper receptacle body 10 (not shown), the lower receptacle body 20 (not shown) and the die table 30 rotate synchronously about a rotation axis extending vertically. The upper receptacle body 10 (not shown), the lower receptacle body 20 (not shown) and the die table 30 form the rotary turret of the tableting device 2. A stator element of the tableting device is not shown in FIG. 3. Typically, the stator element comprises an upper and a lower cam profile guide or roller actuating respectively the upper 12 and lower 22 punches, when the punches 12, 22 rotate with their respective upper 10 (not shown) and lower 20 receptacle body (not shown). The upper 12 and lower 22 punches can comprise an end surface 18, 28 that slides on a corresponding cam profile guide surface or rolls on a roller surface (not shown). The opposite end (tip) 14, 24 of the upper 12 or lower 22 punches can reciprocate in the corresponding working bore 42. In operation, a powder composition, for instance, is fed by a feeder assembly (not shown). The powder composition is then confined in a variable volume defined by the ends (tips) of the corresponding upper 12 and lower 22 punch, as well as the inner lateral surface of the corresponding working bore 42. During at least one rotation cycle, two opposed upper 12 and lower 22 punch ends (tips) get closer to each other and compress the powder composition so as to form a tablet, for example. The formed tablet is then ejected from the working bore. For instance, the corresponding upper punch tip end is extracted from its working bore, leaving a free opening, while the corresponding lower punch end moves upwards and preferably beyond the upper surface of the corresponding die so that the formed tablet is pushed out of the working bore 42. Then, the tablet can be transferred to another location, for instance an outlet. Once the working bore 42 is free, it can be filled again with a powder composition.

Furthermore the punches of the invention are thinner than those of the prior art (e.g. punches defined according to ISO 18084:2011(E)) so that at larger number can be accommodated on a pitch. The punches of the invention are therefore less bulky, reducing the inertial forces. Advantageously, the selected punches 12, 22 have a barrel diameter (referenced as D1 in table 1) smaller than the lower D1 value encountered in ISO 18084:2011(E), namely 19 mm, preferably less than 14 mm, more preferably less than 12.5 mm.

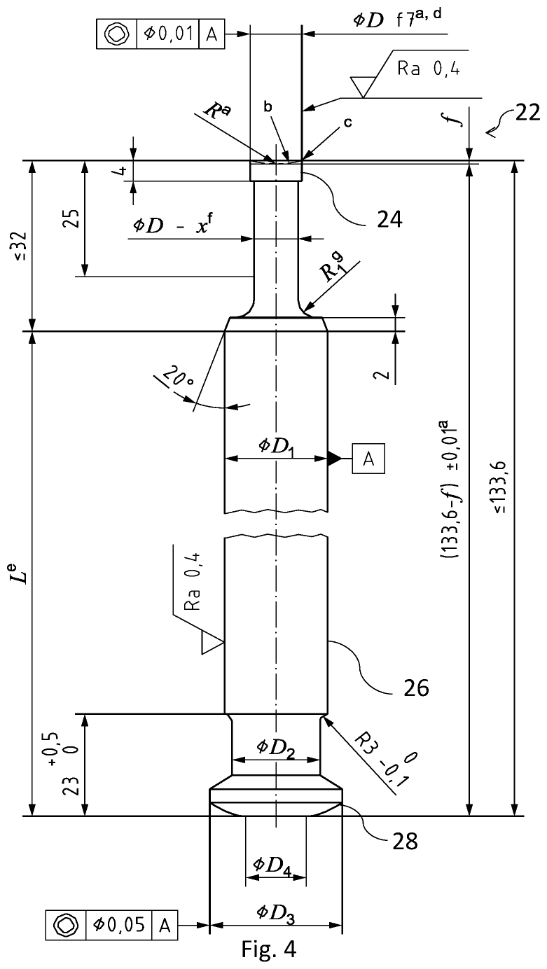

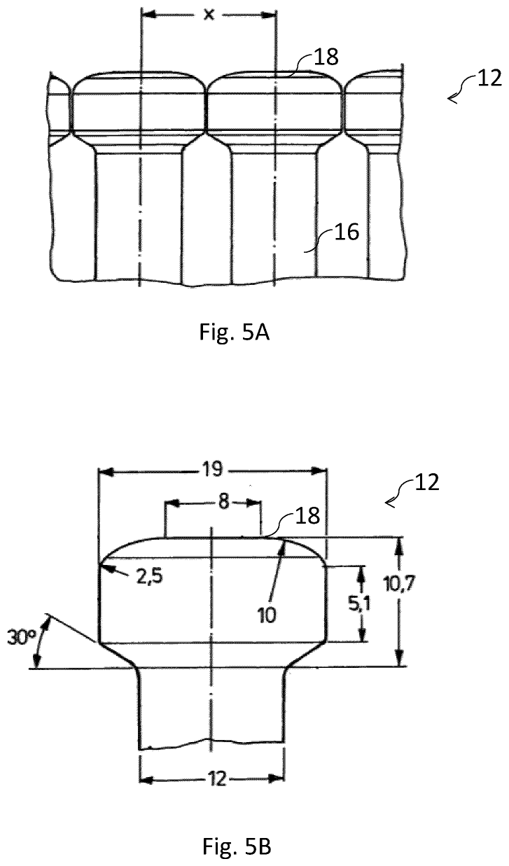

FIG. 4 shows a lower punch according to standard ISO 18084:2011(E). Some reference diameters such as D1 are shown in the table 1 below. It should be noted that that the diameter of the tip of the lower punch is to be selected by the user and is therefore not defined in this standard.

Typically, the diameter of the lower or upper punch tip is smaller than or equal to the barrel diameter D1.

TABLE 1
ISO 18084:2011(E) a lower punch (dimensions in millimeters)

| | D₂ | D₃ | | L₁ |
|---|---|---|---|---|
| D₁ | 0 | 0 | D₄ | 0 |
| h6 | −0.1 | −0.1 | ±0.2 | −0.2 |
| 19 | 15.8 | 25.27 | 9.6 | 20.7 |
| 25.35 | 22 | 31.6 | 16 | 27 |

It is not compulsory that a lower/upper punch fulfils the requirement of ISO 18084:2011(E). For instance, European patent EP2111972 B1, the content of which should be incorporated in the present demand, shows an example of punches that do not comply with ISO 18084:2011(E). These punches are also known as non-standard tooling.

Advantageously, the outer contour of the die insert (a.k.a “die”) according to the invention, meets the requirement of ISO 18084:2011(E). It should be noted that ISO 18084:2011(E) defines a single working bore die insert 40 while the present invention relates to a two working bore solution.

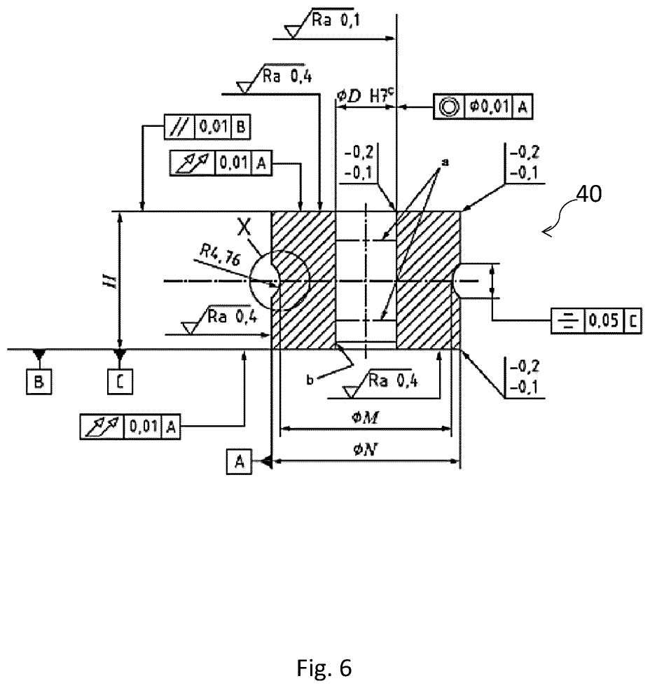

FIG. 6 shows a typical die insert 40 with one bore according to ISO 18084:2011(E) and table 2 shows reference values, such as the outer diameter of the die insert (N).

TABLE 2
ISO 18084:2011(E): die insert (dimensions in millimeters)

| N | M | H |
|---|---|---|
| h6 | ±0.1 | h6 |
| 21 | 19.4 | 22.22 |
| 24 | 21.5 | |
| 30.16 | 27.8 | |
| 38.1 | 35.7 | 23.81 |

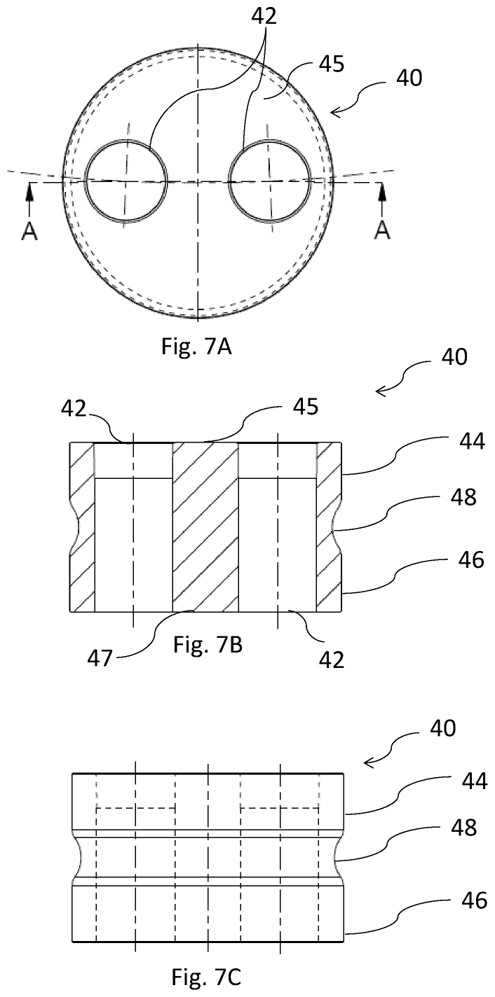

FIGS. 7A, 7B and 7C show a die insert 40 with only two bores 42 according to the invention.

FIG. 7A shows a top view of the die insert 40. The two through bores 42 are positioned on both sides of a symmetric plane. Preferably, the two through bores 42 are disposed symmetrically along a circular arc passing by the center of the die insert 40.

FIG. 7B represents a sectional view of the die insert 42, while FIG. 7C discloses a side view. As discussed above, the outer contour can meet the requirements of ISO 18084:2011(E). The inner contour of both bores can also follow the requirements of this standard, that defines a single bore die insert.

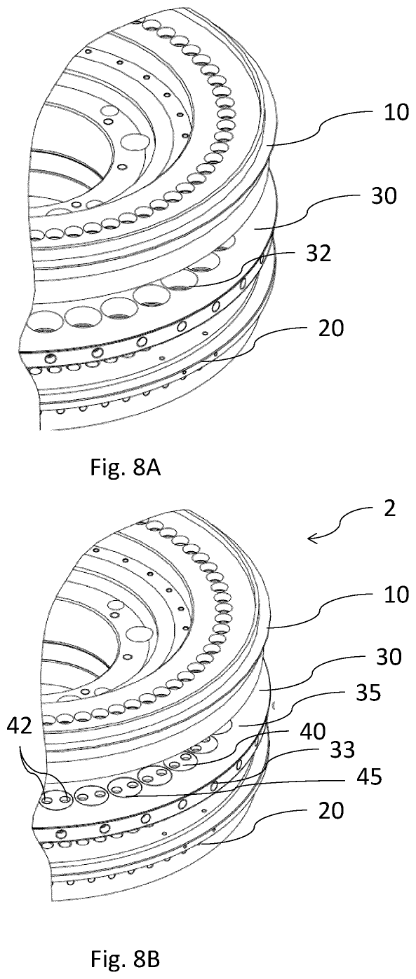

FIG. 8A represents a partial view of the upper receptacle body 10, the die table 30 and the lower receptacle body 20 according to the invention, when the die inserts 40 are not disposed on said table 30.

FIG. 8B only differs from FIG. 8A in that the die inserts are arranged in their recesses 32. Locking pins can be screwed into radial bores 33 opening on a lateral (outer) surface of the die table 30. The die table upper face 35 is flush with the die insert upper faces 45. The die table lower face 37 can also flush with the die insert lower faces.

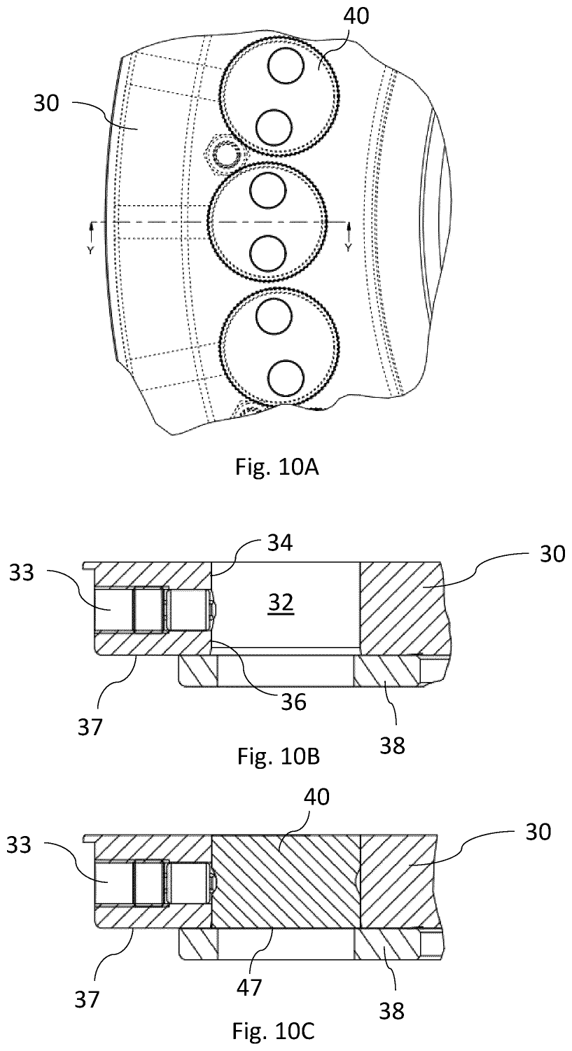

Referring now briefly to FIG. 10A, which represents a top view of a possible embodiment of a die table 30, the position of the radial bores 33 is shown. FIG. 10B represents a cross-sectional view along the plane Y-Y without a die insert, and FIG. 10C represents the cross-section including a die insert 40. A die plate 38 is mounted onto the die table lower face 37 which defines the vertical position of the die insert in the radial bore opening by aligning the lower face 47 to the die table lower face 37. While the die plate 38 in the position shown is positioned such that the lower face 47 of the die insert 40 is at the same level as the die table lower face 37, other configurations are conceivable as long as the die plate 38 ensures that the die inserts are positioned at a well-defined vertical position. Additional positioning means may be present, including an additional recess in the die plate 38, or the die plate 38 may protrude into the receiving recess 32.

Also visible in FIGS. 10B and 10C are inner surfaces 34, 36 of the receiving recess 32, of which inner surface 34 constitutes an upper or first circular cylindrical inner surface and inner surface 36 constitutes a lower or second circular cylindrical inner surface.

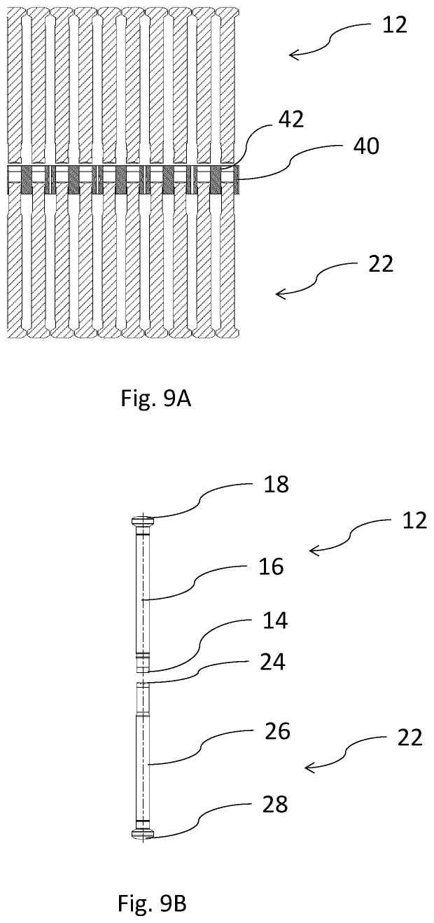

FIG. 9A represents a sectional view of a circumferential row of punches 12, 22 reciprocating in their working bores 42.

FIG. 9B shows a side view of an upper 12 and a lower punch 22. The upper/lower punch 12, 22 comprises a single tip 14, 24 adapted to reciprocate in one of the corresponding working bores 42 (not shown in FIG. 9B). The upper/lower 12, 22 punch comprises barrel portion 16, 26 adapted to reciprocated in the complementary bores formed respectively in the upper 10 or lower 20 respectable body (not shown in FIG. 9B). The barrel portion 16, 26 comprises a cylindrical outer surface with a barrel diameter “D1”. The designation “D1” is used so that the non-standard punches 12, 22 according to the invention can be compared with the standard punches. The use of the designation “D1” should not be interpreted as if ISO 18084:2011(E) defined the entire shape of the punches 12, 22. It has been found that the barrel 16, 26 can advantageously have a barrel diameter D1 lower than 45% of the diameter of the die insert outer diameter, namely diameter N. As for the designation “D1”, the designation “N” is used so that the non-standard die insert 40 according to the invention (with two bores) can be compared with the standard insert with one bore. The use of the designation “N” should not be interpreted as if ISO 18084:2011(E) defined the entire shape of the die insert. With an upper value of 45%, two through bores 42 can be foreseen without significant reduction of the mechanical resistance. Furthermore, there is just enough material between the two through working bores 42. Equally, there is also enough material between a through bore and the lateral (outer) surface 44, 46 of the die insert 40.

The number of working bores is preferably limited to two. However, a die insert with three, more, even four working bores can be foreseen.

The invention articulated around a dissymmetry between the number of die inserts and punches can be generalized to punches with multiple tips, wherein the number of working bores per die insert is multiplied by the number of tips. Even if the impossibility to evaluate weight of individual tablets during compression process renders a multiple tip solution less attractive than a single tip solution, the use of punches with multiple tips can still be regarded as a non-obvious alternative solution to existing tableting device using punches multiple tips. Furthermore the tableting device can be used with single or multiple tip punches, offering modularity.

### LIST OF REFERENCE NUMERALS

2 tableting device
10 upper receptacle body
12 upper punch
14 upper punch tip
16 upper punch barrel
18 upper punch head
20 lower receptacle body
22 lower punch
24 upper punch tip
26 upper punch barrel
28 upper punch head
30 die table
32 receiving recess
33 radial bore
34 (upper or first) circular cylindrical inner surface
35 die table upper face
36 (lower or second) circular cylindrical inner surface
37 die table lower face
38 die plate
40 die insert
42 die insert bore
44 (first or upper) cylindrical outer surface
45 die insert upper face
46 (second or lower) circular cylindrical outer surface
47 die insert lower face
48 annular outer groove

What is claimed is:

1. Tableting device comprising a rotary turret with a rotation axis including:
an upper receptacle body provided with reciprocating upper punches;
a lower receptacle body provided with reciprocating lower punches;
a die table; and
die inserts;
wherein the die table is provided with receiving recesses in which the die inserts are arranged; and
wherein the die inserts and the receiving recesses have a complementary form; and
wherein each die insert comprises at least one circular cylindrical outer surface with a die insert outer diameter (N), the at least one circular cylindrical outer surface facing an inner surface of a corresponding receiving recess; and
wherein each die insert comprises a pair of working bores in which a pair of directly adjacent upper punches respectively reciprocate in use, and in which a corresponding pair of directly adjacent lower punches respectively reciprocate in use.

2. Tableting device according to claim 1, wherein each upper or lower punch comprises a single tip adapted to reciprocate within the corresponding working bore.

3. Tableting device according to claim 1, wherein each upper or lower punch is a single piece.

4. Tableting device according to claim 1, wherein the pair of working bores is arranged circumferentially about the rotation axis.

5. Tableting device according to claim 1, wherein the pair of working bores (42) is a pair of through bores opening on an upper (45) and a lower face (47) of the corresponding die insert (40).

6. Tableting device according to claim 5, wherein the die table comprises an upper and a lower face, and wherein each die insert upper face is flush with the die table upper face.

7. Tableting device according to claim 1, wherein the at least one circular cylindrical outer surface comprises a first circular cylindrical outer surface and a second cylindrical outer surface positioned below the first circular cylindrical outer surface, the first and second circular cylindrical outer surfaces having the same outer diameter (N).

8. Tableting device according to claim 7, wherein each die insert comprises an annular outer groove positioned between the first and the second circular cylindrical outer surfaces.

9. Tableting device according to claim 1, wherein each die insert has an outer lateral surface, the dimensions of which meet the requirements of standard ISO 18084:2011(E).

10. Tableting device according to claim 1, wherein each die insert comprises only two working bores.

11. Tableting device according to claim 1, wherein the number of working bores is twice the number of die inserts.

12. Tableting device according to claim 1, wherein in each receiving recess, the inner surface is a first circular cylindrical inner surface positioned above a second circular cylindrical inner surface of the recess, the first and second circular cylindrical inner surfaces having the same diameter.

13. Tableting device according to claim 1, wherein the diameter of the at least one outer surface is a value selected from 38.1, 30.16, 24, or 21 mm.

14. Tableting device according to claim 1, wherein each upper or lower punch comprises a barrel portion for guiding the punch in the respective upper or lower receptacle body, the barrel portion comprising a cylindrical outer surface with a barrel diameter (D1), wherein the barrel diameter is lower than 45% of the die insert outer diameter (N).

15. Tableting device according to claim 1, wherein the barrel diameter (D1) is less than 14 mm, more preferably less than 12.5 mm.

16. Tableting device according to claim 1, wherein the diameter of the lower or upper punch tip is lower than or equal to the barrel diameter (D1).

17. Tableting device according to claim 1, wherein each die insert is a single piece.

18. Tableting device according to claim 1, wherein each die insert is adapted to be inserted in a direction parallel to the rotation axis.

19. Tableting device according to claim 1, wherein the at least one circular cylindrical outer surface encircles the pair of working bores.

20. Tableting device according to claim 1, wherein the inner surface is a closed surface.

21. Tableting device according to claim 1, wherein each die insert comprises a further working bore, and wherein the pair of working bores and the further bore are arranged on the same pitch circle.

22. Tableting device according to claim 1, wherein the number of lower or upper punches is a positive integer multiple of the number of die inserts.
